(19) United States
(12) Patent Application Publication
(10) Pub. No.: US 2015/0046931 A1
(43) Pub. Date: Feb. 12, 2015

(54) APPARATUS AND METHOD FOR CONTROLLING A SYSTEM CALL IN A PORTABLE TERMINAL

(71) Applicant: Samsung Electronics Co., Ltd., Gyeonggi-do (KR)

(72) Inventor: Zygmunt Bazyli KRYNICKI, Warsaw (PL)

(73) Assignee: Samsung Electronics Co., Ltd.

(21) Appl. No.: 14/305,775

(22) Filed: Jun. 16, 2014

(30) Foreign Application Priority Data
Aug. 7, 2013 (KR) 10-2013-0093753

(51) Int. Cl. G06F 9/54

(52) U.S. Cl. CPC G06F 9/54
USPC 719/313

(57) ABSTRACT

An apparatus and a method for controlling a system call in a portable terminal are provided. The method includes searching for a first process control block of a task to which a first software interrupt is applied; detecting a system call interface table from the retrieved first process control block; searching for a system call service routine from the detected system call interface table; and executing a system call using the retrieved system call service routine.

### PRIORITY

This application claims priority under 35 U.S.C. §119(a) to a Korean Patent Application filed in the Korean Intellectual Property Office on Aug. 7, 2013 and assigned Serial No. 10-2013-0093753, the entire content of which is incorporated herein by reference.

### BACKGROUND OF THE INVENTION

1. Field of the Invention

The present invention relates generally to a portable terminal, and more particularly, to a method and an apparatus for controlling a system call in a portable terminal.

2. Description of the Related Art

Portable terminals such as a smart phone, a tablet, and the like, provide various useful functions to users through varied applications. Therefore, the portable terminal has been developed to provide various types of information through various functions in addition to a voice call function. In particular, the portable terminal executes a predetermined application so as to provide a predetermined function to a user.

When a predetermined application utilizes hardware included in a portable terminal, the predetermined application calls a function of a desired hardware under a system call instruction.

However, when an operating system (OS) of a portable terminal is updated or is different from an OS supported by a predetermined application, the portable terminal may not execute the predetermined application, since there is difficulty in removing or changing one of the system calls unless execution of a program (for example, an application) is disabled.

Therefore, there is a need for a method that is capable of executing and changing a system call associated with a predetermined application while the predetermined application is executed.

### SUMMARY OF THE INVENTION

The present invention has been made to address at least the problems and disadvantages described above and to provide at least the advantages described below. Accordingly, an aspect of the present invention is to provide a system call controlling method and apparatus in a portable terminal for executing a system call associated with a predetermined application while the predetermined application is executed.

Another aspect of the present invention is to provide a system call controlling method and apparatus in a portable terminal for changing a system call associated with a predetermined application while the predetermined application is executed.

In accordance with an aspect of the present invention, an apparatus for controlling a system call in a portable terminal is provided. The apparatus includes a controller configured to search for a first process control block of a task to which a first software interrupt is applied, detect a system call interface table from the retrieved first process control block, search for a system call service routine from the detected system call interface table, and execute a system call using the retrieved system call service routine.

In accordance with another aspect of the present invention, a method of controlling a system call in a portable terminal is provided. The method includes searching for a first process control block of a task to which a first software interrupt is applied; detecting a system call interface table from the retrieved first process control block; searching for a system call service routine from the detected system call interface table; and executing a system call using the retrieved system call service routine.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram of a portable terminal according to an embodiment of the present invention;

FIG. 2 illustrates an Android structure according to an embodiment of the present invention;

FIG. 3 is a flowchart illustrating execution of a system call in a portable terminal according to a first embodiment of the present invention;

FIG. 4 is a flowchart illustrating changing a system call interface in a portable terminal according to a second embodiment of the present invention;

FIG. 5 illustrates a program language that executes a system call according to the first embodiment of the present invention; and

FIG. 6 illustrates a program language that changes a system call interface according to the second embodiment of the present invention.

### DETAILED DESCRIPTION OF EMBODIMENTS OF THE PRESENT INVENTION

Hereinafter, various embodiments of the present invention will be described with reference to the accompanying drawings. It shall be noted that in the following description, the same elements will be designated by the same reference numerals although they are shown in different drawings.

The terminal according to an embodiment of the present invention includes a portable terminal and a fixed terminal. The portable terminal is an electronic device that is easily carried, which may be, for example, a video phone, a mobile phone, a smart phone, an IMT-2000 (International Mobile Telecommunication 2000) terminal, a WCDMA terminal, a UMTS (Universal Mobile Telecommunication Service) terminal, a PDA (Personal Digital Assistant), a PMP (Portable Multimedia Player), a DMB (Digital

Multimedia Broadcasting) terminal, an E-Book, a portable computer (for example, a notebook computer or a tablet computer), or a digital camera. The fixed terminal includes a desktop personal computer or the like.

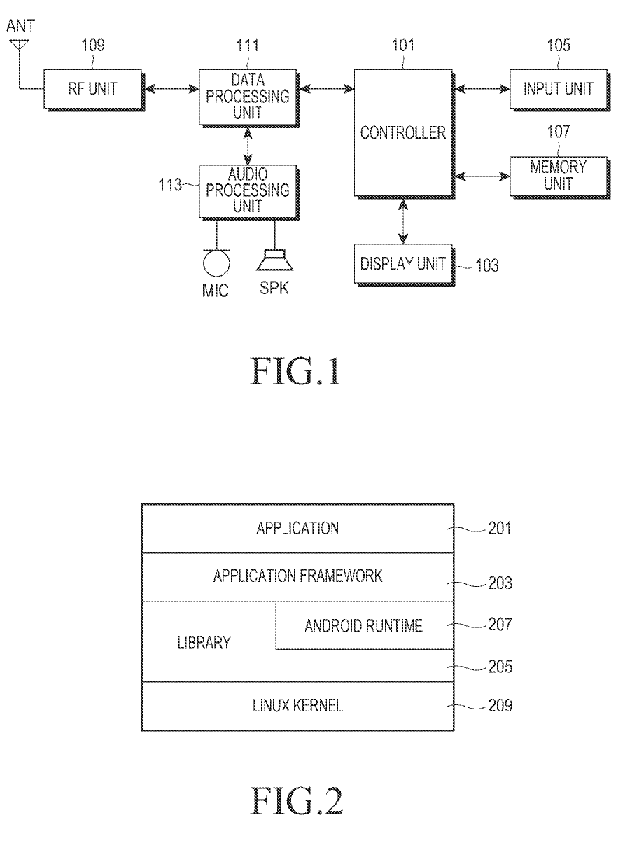

FIG. 1 is a block diagram of a portable terminal according to an embodiment of the present invention.

Referring to FIG. 1, the portable terminal includes a controller 101, a display unit 103, an input unit 105, a memory unit 107, a Radio Frequency (RF) unit 109, a data processing unit 111, and an audio processing unit 113.

The RF unit 109 performs a wireless communication function of a terminal. In particular, the RF unit 109 includes an RF transmitter to up-convert and amplify a frequency of a transmitted signal, an RF receiver to lownoise amplify and down-convert a received signal, and the like. The data processing unit 111 includes a transmitter that encodes and modulates a transmitted signal, a receiver that demodulates and decodes a received signal, and the like. The data processing unit 111 is formed of a modem and a codec. The codec includes a data codec that processes packet data and the like, and an audio codec that processes an audio signal such as a voice and the like.

The audio processing unit 113 plays back a received audio signal output from an audio codec of the data processing unit 111, or transmits an audio signal, which is generated from a microphone, to an audio codec of the data processing unit 111. The input unit 105 includes keys required for inputting number and character information and function keys required for setting various functions.

The display unit 103 displays an image signal on a screen, and displays output data which are requested by the controller 101. When the display unit 103 is embodied as a touch screen, for example, according to a capacitive scheme, a resistive scheme, or the like, the input unit 105 may include a minimum number of predetermined keys, and the display unit 103 may substitute a part of keys of the input unit 105 for a input function.

The memory unit 107 includes a program memory and a data memory. The program memory stores a booting and Operating System (OS) for controlling general operations of a portable terminal, and the data memory stores various data generated while a portable terminal operates. For example, the OS may be an Android operating system. Here, Android is a software platform that includes an operating system for a portable terminal, middleware and an application program.

The controller 101 controls general operations of a portable terminal. Particularly, the controller 101 executes an OS stored in the memory unit 107, for example, Android, and executes a system call or changes a system call interface using the executed Android. Here, the system call refers to calling a program procedure (a function in C language) for a function of an OS in an application. Directly accessing a memory or an input/output device is not allowed in an application under an OS, and thus, the system call is used to access a file, an input/output device, or a memory.

FIG. 2 illustrates an Android structure according to an embodiment of the present invention.

Referring to FIG. 2, the Android OS includes a Linux kernel 209, a library 205, an Android runtime 207, an application framework 203, and an application 201.

Each component element will be described as follows. The Linux kernel 209 is the lowest layer of the Android OS, and performs a low level management function such as managing a background thread, a memory, security, a device, and the like. The library 205 includes libraries that application programs commonly use, and the Android runtime 207 provides an optimized environment for executing an application and includes a Dalvik virtual machine and a Java core library.

The application framework 203 is referred to as an Application Programming Interface (API) of Android. An application is incapable of directly calling the Linux kernel 209 or the library 205, but may call the Linux kernel 209 or the library 205 through the API. The application 201 refers to an application program such as a game, a utility, and the like.

To execute a system call, the application 201 executes a software interrupt instruction. Here, a software interrupt refers to a program-generating type of an interrupt that stops a current process to request a service provided by an interrupt routine that is a set of independent instructions designed for executing a required task. For example, a program generates a software interrupt, in order to refer a microprocessor to a video routine under a control of a computer input/output system, or in order to enable the microprocessor to read an input from a mouse or a keyboard. Particularly, a software interrupt requests execution of a system call.

When a software interrupt instruction is executed, the Linux kernel 209 searches for a task to which a software interrupt is applied, and searches for a Process Control Block (PCB) of the retrieved task.

Here, the task is a unit of work when an OS allocates and processes resources. The task is performed to attain effective use of resources and improvement of throughput in multiprocessing, and each program allocates system resources via a task, and operates. The PCB refers to a storage place where an OS stores useful information associated with a process. The PCB includes information associated with a current state of a process, a unique identifier of a process, a priority of a process, a pointer indicating a storage memory part in which a process is contained, a pointer indicating resources allocated to a process, a place where register contents are stored, and the like.

The application 201 receives the retrieved PCB from the Linux kernel 209, and detects a system call interface table from the received PCB. The system call interface reads a software interrupt when an instruction for requesting a service from a kernel or for manufacturing hardware is generated, in order to call a corresponding function. The system call interface table includes at least one system call function.

The application 201 searches for a system call service routine corresponding to the task to which the software interrupt is applied, from the detected system call interface table. In other words, the application 201 searches for a system call function corresponding to the task to which the software interrupt is applied from the detected system call interface table.

The Linux kernel 209 receives the retrieved system call service routine from the application 201, and executes a system call using the received system call service routine.

To change the system call interface, the application 201 executes a software interrupt instruction. Here, a software interrupt requests the Linux kernel 209 to select a system call interface table.

When the software interrupt is received, the Linux kernel 209 checks a process to decide whether a system call interface is required. Here, the process is a program that is currently executed. The Linux kernel 209 searches for a task to which the software interrupt is applied, and searches for a PCB of the retrieved task.

The Linux kernel 209 updates the retrieved PCB by changing a system call interface table included in the retrieved PCB into a new system call interface table. In this example, the Linux kernel 209 changes a previous system call service routine included in the system call interface table included in the PCB into a new system call service routine based on information including the new system call service routine corresponding to the previous system call service routine, into a new system call interface table.

Here, the information is generated by an OS, and the information enables execution of a previous application in an updated version of the OS that is aware of a configuration of a previous system call interface.

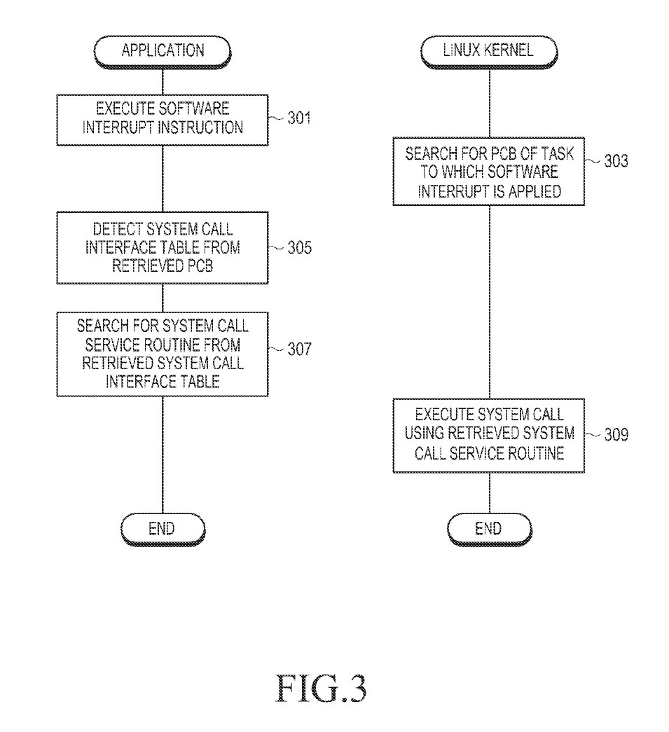

FIG. 3 is a flowchart illustrating execution of a system call in a portable terminal according to a first embodiment of the present invention.

Referring to FIG. 3, in step 301, the application 201 executes a software interrupt instruction and proceeds to step 303. Here, a software interrupt is a program-generating type of an interrupt that stops a current process so as to request a service that is provided by an interrupt routine, which is a set of independent instructions designed for executing a required task. For example, a program generates a software interrupt, in order to refer a microprocessor to a video routine under a control of a computer input/output system, or in order to enable the microprocessor to read an input from a mouse or a keyboard. In particular, the software interrupt requests execution of a system call.

When the software interrupt instruction is executed in step 303, the Linux kernel 209 searches for a task to which the software interrupt is applied, searches for a PCB of the retrieved task, and proceeds to step 305.

Here, the task is a unit of work when an OS allocates and processes resources. The task is performed to attain effective use of resources and improvement of throughput in multiprocessing, and each program allocates system resources via a task, and operates. The PCB refers to a storage place where an OS stores useful information associated with a process. The PCB includes information associated with a current state of a process, a unique identifier of a process, a priority of a process, a pointer indicating a storage memory part in which a process is contained, a pointer indicating resources allocated to a process, a place where register contents are stored, and the like.

In step 305, the application 201 receives the retrieved PCB from the Linux kernel 209, detects a system call interface table from the received PCB, and proceeds to step 307. The system call interface reads a software interrupt when an instruction for requesting a service from a kernel or for manufacturing hardware is generated, in order to call a corresponding function. The system call interface table includes at least one system call function.

In step 307, the application 201 searches for a system call service routine corresponding to the task to which the software interrupt is applied, from the detected system call interface table, and proceeds to step 309. In other words, the application 201 searches for a system call function corresponding to the task to which the software interrupt is applied from the detected system call interface table.

In step 309, the Linux kernel 209 receives the retrieved system call service routine from the application 201, and executes a system call using the received system call service routine.

In accordance with the steps, the portable terminal searches for the system call interface associated with the currently executed process, stores detailed items of the system call interface, and establishes a relationship between the task of the OS and the details of the system call interface.

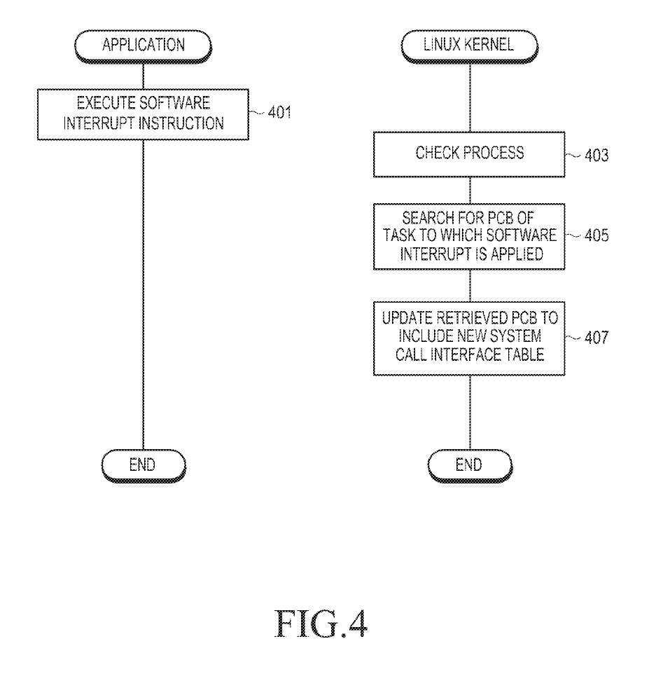

FIG. 4 is a flowchart illustrating changing a system call interface in a portable terminal according to a second embodiment of the present invention.

Referring to FIG. 4, in step 401, the application 201 executes a software interrupt instruction and proceeds to step 403. Here, a software interrupt requests the Linux kernel 209 to select a system call interface table.

In step 403, when the software interrupt is received, the Linux kernel 209 checks a process to decide whether a system call interface is required, and proceeds to step 405. Here, the process refers to a currently executed program. In step 405, the Linux kernel 209 searches for a task to which the software interrupt is applied, searches for a PCB of the retrieved task, and proceeds to step 407.

In step 407, the Linux kernel 209 updates the retrieved PCB by changing a system call interface table included in the retrieved PCB into a new system call interface table. In this example, the Linux kernel 209 changes a previous system call service routine included in the system call interface table included in the PCB into a new system call service routine based on information including the new system call service routine corresponding to the previous system call service routine, and thus, changes the system call interface table included in the PCB into the new system call interface table,

Here, the information is generated by an OS, and the information enables execution of a previous application in an updated version of the OS that is aware of a configuration of a previous system call interface.

In accordance with the steps, the portable terminal changes the previous system call interface into a new system call interface.

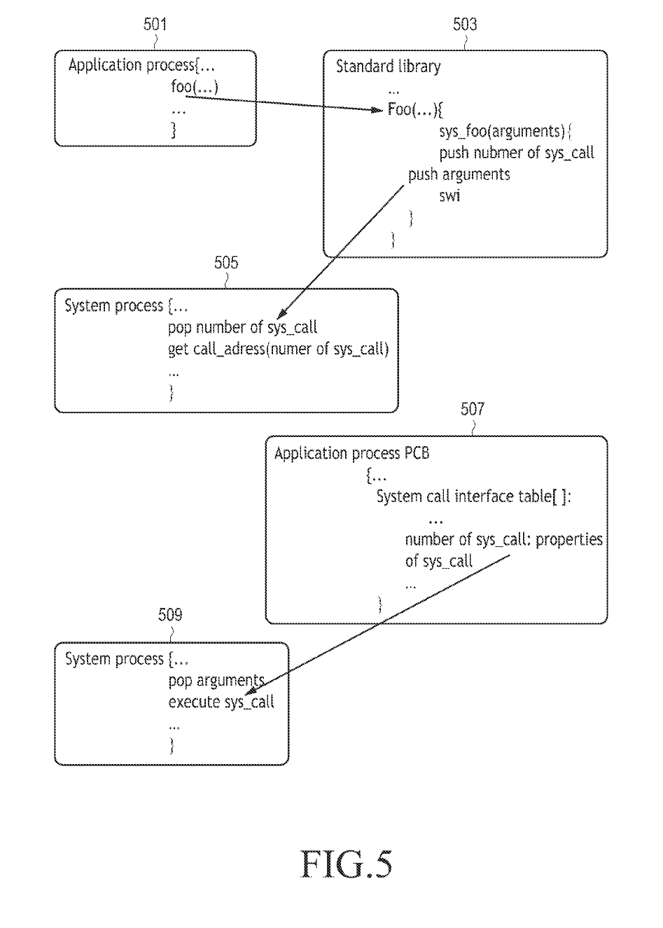

FIG. 5 illustrates program languages that execute a system call according to the first embodiment of the present invention.

Referring to FIG. 5, the application 201 executes a software interrupt instruction through program languages 501 and 503. Particularly, a software interrupt requests execution of a system call. In this example, the application 201 requests execution of a software interrupt instruction, and the library 205 executes a library corresponding to the corresponding software interrupt.

When the software interrupt instruction is executed through a program language 505, the Linux kernel 209 searches for a task to which the software interrupt is applied, and searches for a PCB of the retrieved task.

The application 201 detects a system call interface table from the retrieved PCB through a program language 507, and searches for a system call service routine corresponding to the task to which the software interrupt is applied from the detected system call interface table.

The Linux kernel 209 executes a system call using the retrieved system call service routine through a program language 509.

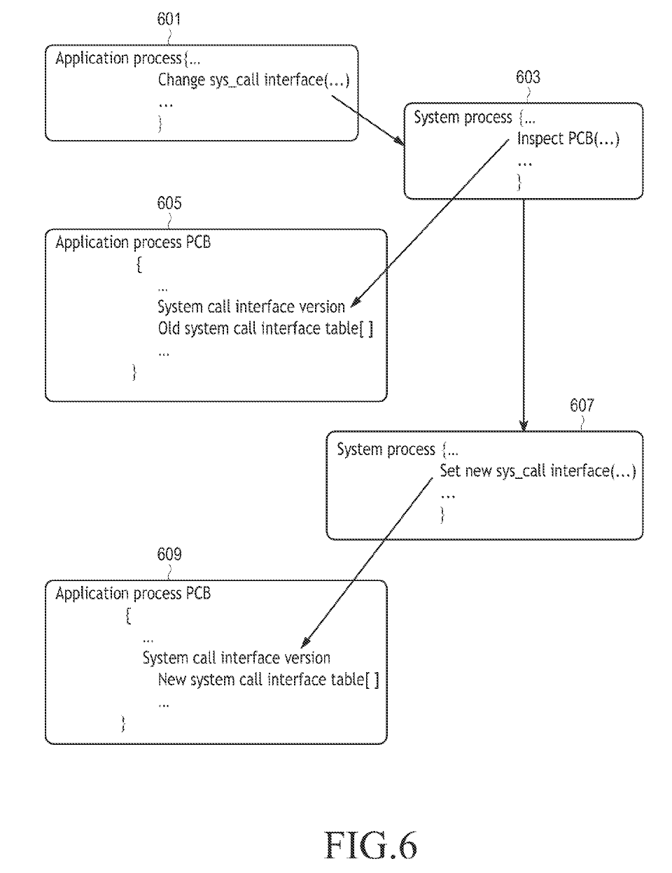

FIG. 6 illustrates program languages that change a system call interface according to the second embodiment.

Referring to FIG. 6, the application 201 executes a software interrupt instruction through a program language 601. Here, a software interrupt requests the Linux kernel 209 to change a system call interface table.

When the software interrupt is received through program languages 603 and 605, the Linux kernel 209 checks a process to decide whether a system call interface is required.

The Linux kernel 209 searches for a task to which the software interrupt is applied through program languages 607 and 609, searches for a PCB of the retrieved task, and updates the retrieved PCB by changing a system call interface table included in the retrieved PCB into a new system call interface table.

The present invention executes other compiler tool chains, system libraries, and executed binary applications generated by another OS. To achieve this, the present invention provides a system call software interrupt for changing a system call interface, and changes a system call interface of an application based on the system call interface provided in a portable terminal.

The present invention simplifies maintaining a system call interface for developing platforms. Therefore, it is possible to manufacture a layer of all system calls again. When a previous system call interface service routine associated with an application moves to an end of a system call interface table, a new system call interface service routine is added to a beginning of the system call interface table.

Also, a code for embodying a system call interface is loaded by demand for a predetermined application. New system calls are optimized while a previous system maintains compatibility. An OS is not required to secure resources when an executed legacy application does not exist.

In accordance with the above, the present invention provides an apparatus and method for controlling a system call in a portable terminal, so as to execute a system call associated with a predetermined application while the predetermined application is executed. Also, the present invention provides an apparatus and a method for controlling a system call in a portable terminal, so as to change a system call associated with a predetermined application while the predetermined application is executed.

The system call controlling method in the portable terminal according to an embodiment of the present invention may be embodied as a computer readable code in a computer readable recoding medium.

The computer-readable recording medium includes all the types of recording devices in which data readable by a computer system are stored. A recording medium, for example, a ROM, a RAM, an optical disc, a magnetic tape, a floppy disc, a hard disc, or a non-volatile memory may be used, and a medium implemented in a type of carrier wave (for example, transmission through the Internet) may also be included in such a recording medium. In addition, the computer-readable recording medium may be stored with codes which are distributed in computer systems connected by a network such that the codes can be read and executed by a computer in a distributed method.

While the description of the present invention has been made with reference to certain embodiments such as a portable terminal, various modifications can be implemented without departing from the scope of the present invention. Therefore, it is apparent that the present invention should be defined by the claims and their equivalents instead of the embodiments.

What is claimed is:

1. An apparatus for controlling a system call in a portable terminal, the apparatus comprising:
a controller configured to search for a first process control block of a task to which a first software interrupt is applied, detect a system call interface table from the retrieved first process control block, search for a system call service routine from the detected system call interface table, and execute a system call using the retrieved system call service routine.

2. The apparatus of claim 1, wherein the controller searches for a system call function corresponding to the task to which the first software interrupt is applied, from the detected system call interface table.

3. The apparatus of claim 1, wherein the first software interrupt requests the system call.

4. The apparatus of claim 1, wherein, when a second software interrupt is received, the controller determines whether a system call interface is required, searches for a second process control block of a task to which the second software interrupt is applied, and updates the retrieved second process control block so that the retrieved second process control block includes a new system call interface table.

5. The apparatus of claim 4, wherein the controller updates the retrieved second process control block by changing the system call service routine included in the system call interface table into a new system call service routine, based on information including the new system call service routine corresponding to the previous system call service routine.

6. The apparatus of claim 4, wherein the second software interrupt requests changing of the system call interface table.

7. A method of controlling a system call in a portable terminal, the method comprising:
searching for a first process control block of a task to which a first software interrupt is applied;
detecting a system call interface table from the retrieved first process control block;
searching for a system call service routine from the detected system call interface table; and
executing a system call using the retrieved system call service routine.

8. The method of claim 7, wherein searching for the system call service routine comprises:
searching for a system call function corresponding to the task to which the first software interrupt is applied, from the detected system call interface table.

9. The method of claim 7, wherein the first software interrupt requests the system call.

10. The method of claim 7, further comprising:
when a second software interrupt is received, determining whether a system call interface is required;
searching for a second process control block of a task to which the second software interrupt is applied; and
updating the retrieved second process control block so that the retrieved second process control block includes a new system call interface table.

11. The method of claim 10, wherein updating the retrieved second process control block updates the retrieved second process control block by changing the system call service routine included in the system call interface table into a new system call service routine, based on information including the new system call service routine corresponding to the previous system call service routine.

12. The method of claim 10, wherein the second software interrupt requests changing of the system call interface table.
